(19) United States
(12) Patent Application Publication
(10) Pub. No.: US 2026/0308394 A1
(43) Pub. Date: Oct. 8, 2026

(54) FLAME RETARDANT POLYMERIC COMPOSITIONS

(71) Applicant: Dow Global Technologies LLC, Midland, MI (US)

(72) Inventors: Bharat I. Chaudhary, Princeton, NJ (US); Richard I. Tapper, Philadelphia, PA (US)

(21) Appl. No.: 19/481,248

(22) PCT Filed: Jun. 26, 2024
(86) PCT No.: PCT/US2024/035504

§ 371 Date: Nov. 4, 2025

Related U.S. Application Data
(60) Provisional application No. 63/523,931, filed on Jun. 29, 2023.

(51) Int. Cl. C09D 5/18; C09D 7/61; C09D 7/63; C09D 123/08; H01B 3/44

(52) U.S. Cl. CPC C09D 5/185; C09D 7/61; C09D 7/63; C09D 123/0892; H01B 3/441

(57) ABSTRACT

A moisture curable polymeric composition includes 10 wt % to 99 wt % of a silane-functionalized polyolefin based on the total weight of the moisture curable polymeric composition and 1 wt % to 90 wt % of an intumescent flame-retardant mixture based on the total weight of the moisture curable polymeric composition. The intumescent flame-retardant mixture comprises piperazine pyrophosphate and from 15 wt % to 55 wt % of a phosphoric acid compound based on the total weight of the intumescent flame-retardant mixture.

### BACKGROUND

### Field of the Disclosure

The present disclosure relates to polymeric compositions, and more specifically to filled flame retardant polymeric compositions.

### INTRODUCTION

Jacket and/or insulation layers of wires and cables utilized in structures often must exhibit certain threshold flame retardancy properties. Thermoplastic ethylene-based polymers (also known as polyethylenes) are often utilized as the base polymers in the compositions of such jackets or insulations when incorporating high levels of halogen-free flame retardant (“HFFR”) fillers in such materials, however thermoplastic compositions lack sufficient resistance to flow and deformation when exposed to elevated temperatures. Crosslinked polyolefin compositions are used in a variety of applications where such heat resistance and good mechanical properties are required. The crosslinking of a polyolefin transforms a thermoplastic composition into a thermoset composition which increases its resistance to deformation and flow at elevated temperatures because the polymer chains are linked together, unlike in the case of a thermoplastic composition.

There are a variety of methods to crosslink polymeric compositions including vulcanization for peroxide-induced crosslinking, electron beam based crosslinking and moisture-induced crosslinking through the use of silane functionalization. Silane crosslinking of polymeric compositions utilizing silane functionalization of the polymers typically requires use of silanol condensation catalysts such as tin-based dibutyltin dilaurate and/or strong acids such as sulfonic acids. The presence of moisture in such formulations is undesirable as it can lead to premature crosslinking during melt extrusion. Moisture-induced crosslinking of the formulations occurs in a subsequent step after fabrication of the article, through the diffusion of water into the article.

Polymeric compositions are typically considered to be crosslinked if they exhibit a gel content of 10 wt % or greater as measured according to ASTM D2765. The level of flame retardancy (if any) required in a moisture-cured polymeric composition will depend on its intended application, with the UL-2556 Horizontal Burn Test being an example in the arena of wire and cable applications. Typically, a flame retardant moisture-cured polymeric composition should exhibit a peak tensile strength of 600 psi (4 megapascals, MPa) or greater, a tensile elongation at break of 50% or greater, hot creep (also known as hot set elongation)≤175% measured according to ICEA Standard T-28-562 and, for horizontal burn applications, should exhibit a char length of 100 mm or less and no dripping or cotton ignition when tested according to the UL-2556 Horizontal Burn Test.

Intumescent compounds can be used as halogen-free flame retardant (“HFFR”) fillers in polymeric applications. Intumescent compounds operate by expanding when exposed to heat thereby volume diluting the available polymeric material available for combustion. For example, United States Patent Application Publication number 2003/0088000A1 discloses the use of intumescent compounds with polymeric systems such as polypropylene. Intumescent compounds have not been used in silane crosslinked (moisture curable) systems before possibly because they often contain pentaerythritol (as a charring agent) which can undergo dehydration in the presence of an acid or acid source (such as ammonium polyphosphate, which is a typical component of intumescent compounds) to yield water that in turn would yield premature crosslinking during melt extrusion of compositions containing silane functionalized polymers. Equation 1 of Applied Catalysis A: General 253 (2003) 29-32 depicts the generation of water from acid-catalyzed dehydration of pentaerythritol.

In view of the forgoing, it would be surprising to discover a silane crosslinked (moisture curable) polymeric composition including an intumescent flame-retardant mixture which does not crosslink prematurely during melt extrusion and which exhibits the above-noted peak tensile strength, tensile elongation at break and passage of the Horizontal Burn Test.

### SUMMARY OF THE DISCLOSURE

The inventors of the present disclosure have discovered a silane crosslinked (moisture curable) polymeric composition including an intumescent flame-retardant mixture which does not crosslink prematurely during melt extrusion and which exhibits the above-noted peak tensile strength, tensile elongation at break and passage of the Horizontal Burn Test.

The present disclosure is the result of using intumescent flame-retardant mixtures comprising piperazine pyrophosphate and a phosphoric acid compound that do not undergo acid catalyzed decomposition to yield problematic water during melt extrusion, the evidence of which would be surface roughness due to premature crosslinking of the silane-functionalized polyolefin.

According to a first feature of the disclosure, a moisture curable polymeric composition comprises 10 wt % to 99 wt % of a silane-functionalized polyolefin based on the total weight of the moisture curable polymeric composition; and 1 wt % to 90 wt % of an intumescent flame-retardant mixture based on the total weight of the moisture curable polymeric composition, wherein the intumescent flame-retardant mixture comprises piperazine pyrophosphate and from 15 wt % to 55 wt % of a phosphoric acid compound based on the total weight of the intumescent flame-retardant mixture.

According to another feature of the disclosure, the silane functionalized polyolefin is a silane functionalized ethylene-based polymer.

According to another feature of the disclosure, the polymeric composition comprises 30 wt % or greater of the silane functionalized polyolefin based on a total weight of the moisture curable polymeric composition.

According to another feature of the disclosure, the polymeric composition comprises 15 wt % or greater of the intumescent flame-retardant mixture based on a total weight of the moisture curable polymeric composition.

According to another feature of the disclosure, the intumescent flame-retardant mixture comprises from 25 wt % to 45 wt % of phosphoric acid compound based on the total weight of the intumescent flame-retardant mixture.

According to another feature of the disclosure, the phosphoric acid compound is selected from the group consisting of melamine polyphosphate, ammonium polyphosphate, or combinations thereof.

According to another feature of the disclosure, the moisture curable polymeric composition exhibits a density of 1.70 g/cc or less as measured according to ASTM D792.

According to another feature of the disclosure, the moisture curable polymeric composition is free of dibutyltin dilaurate and sulfonic acid.

According to another feature of the disclosure, a moisture cured polymeric composition prepared from the moisture curable polymeric composition exhibits one or more of the following properties: a peak tensile strength of 4 megapascals or greater as measured according to ASTM D638; a tensile elongation at break of 50% or greater as measured according to ASTM D638; and 175% or less hot creep as measured according to UL 2556 Section 7.9.

According to another feature of the disclosure, a coated conductor comprises a conductor; and the moisture-cured polymeric composition positioned around the conductor.

According to another feature of the disclosure, the coated conductor passes a UL-2556 Horizontal Burn Test.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut fur Normung; and ISO refers to International Organization for Standards.

### Moisture Curable Polymeric Composition

The present disclosure is generally directed to a moisture curable polymeric composition. The moisture curable polymeric composition comprises a silane functionalized polyolefin and an intumescent flame-retardant mixture. The moisture curable polymeric composition may exhibit a density of 1.70 g/cc or less as measured according to ASTM D792. For example, the moisture curable polymeric composition may exhibit a density of 1.70 g/cc or less, or 1.65 g/cc or less, or 1.60 g/cc or less, or 1.55 g/cc or less, or 1.50 g/cc or less, or 1.45 g/cc or less, or 1.40 g/cc or less, or 1.30 g/cc or less, or 1.20 g/cc or less, or 1.10 g/cc or less, or 1.00 g/cc or less, or 0.99 g/cc or less, or 0.98 g/cc or less, or 0.97 g/cc or less, or 0.96 g/cc or less, or 0.95 g/cc or less, or 0.94 g/cc or less as measured according to ASTM D792. According to various examples, the moisture curable polymeric composition is free of dibutyltin dilaurate and sulfonic acid.

### Silane-Functionalized Polyolefin

A “silane-functionalized polyolefin” is a polymer that contains silane and equal to or greater than 50 wt %, or a majority amount, of polymerized α-olefin, based on the total weight of the silane-functionalized polyolefin. “Polymer” means a macromolecular compound prepared by reacting (i.e., polymerizing) monomers of the same or different type. As noted above, the moisture curable polymeric composition comprises the silane-functionalized polyolefin. The polyolefin comprises polymerized α-olefins and optionally unsaturated esters.

The silane-functionalized polyolefin may include an α-olefin and silane copolymer (i.e., α-olefin/silane copolymer), a silane-grafted polyolefin, and/or combinations thereof. An “α-olefin and silane copolymer” is formed from the copolymerization of an α-olefin (such as ethylene) and a hydrolyzable silane monomer (such as a vinyl silane monomer) such that the hydrolyzable silane monomer is incorporated into the backbone of the polymer chain prior to the polymer's incorporation into the moisture curable polymeric composition. A “silane-grafted polyolefin” or “Si-g-PO” may be formed by the Sioplas process in which a hydrolyzable silane monomer is grafted onto the backbone of a base polyolefin by a process such as extrusion, prior to the polymer's incorporation into the polymeric composition.

In examples where the silane-functionalized polyolefin is an α-olefin/silane copolymer, the silane-functionalized polyolefin is prepared by the copolymerization of at least one α-olefin and a hydrolyzable silane monomer. In examples where the silane-functionalized polyolefin is a silane grafted polyolefin, the silane-functionalized polyolefin is prepared by grafting one or more hydrolyzable silane monomers on to the α-olefin backbone.

The silane-functionalized polyolefin comprises 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 98.5 wt % or greater, or 99 wt % or greater, while at the same time, 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less of α-olefin and optional unsaturated ester based on a total weight of the silane functionalized polyolefin as measured using Fourier-Transform Infrared (FTIR) Spectroscopy. The α-olefin may include C₂, or C₃ to C₄, or C₆, or C₈, or C₁₀, or C₁₂, or C₁₆, or C₁₈, or C₂₀ α-olefins, such as ethylene, propylene, 1-butene, 1-hexene, 4-methyl-1-pentene, and 1-octene. The unsaturated ester can be an alkyl acrylate, alkyl methacrylate, or vinyl carboxylate.

The silane-functionalized polyolefin may comprise from 0.1 wt %, or 0.3 wt %, or 0.5 wt %, or 0.8 wt %, or 1.0 wt %, or 1.2 wt %, or 1.5 wt %, or 1.6 wt % to 1.8 wt %, or 2.0 wt %, or 2.3 wt %, or 2.5 wt %, or 3.0 wt %, or 3.5 wt %, or 4.0 wt %, or 4.5 wt %, while at the same time, 5.0 wt % or less, or 4.5 wt % or less, or 4.0 wt % or less, or 3.5 wt % or less, or 3.0 wt % or less, or 2.5 wt % or less, or 2.4 wt % or less, or 2.3 wt % or less, or 2.0 wt % or less, or 1.8 wt % or less, or 1.6 wt % or less, or 1.4 wt % or less, or 1.2 wt % or less, or 1.0 wt % or less, or 0.8 wt %, or 0.6 wt % or less of silane based on a total weight of the silane functionalized polyolefin as measured using FTIR Spectroscopy.

The silane-functionalized polyolefin has a density from 0.850 g/cc, or 0.860 g/cc, or 0.875 g/cc, or 0.880, or 0.890 g/cc to 0.900 g/cc, or 0.910 g/cc, or 0.915 g/cc, or 0.920 g/cc, or 0.930 g/cc, or 0.940 g/cc, or 0.950 g/cc or 0.960 g/cc, or 0.965 g/cc, while at the same time, 0.970 g/cc or less, or 0.960 g/cc or less, or 0.950 g/cc or less, or 0.940 g/cc or less, or 0.930 g/cc or less, or 0.920 g/cc or less, or 0.910 g/cc or less, or 0.900 g/cc or less, or 0.890 g/cc or less, or 0.880 g/cc or less, or 0.870 g/cc or less, or 0.860 g/cc or less as measured by ASTM D792.

The silane-functionalized polyolefin may have a melt index as measured according to ASTM D1238 under the conditions of 190° C./2.16 kilogram (kg) weight and is reported in grams eluted per 10 minutes (g/10 min). The melt index of the silane-functionalized polyolefin may be 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, while at the same time, 50.0 g/10 min or less, or 45.0 g/10 min or less, or 40.0 g/10 min or less, or 35.0 g/10 min or less, or 30.0 g/10 min or less, or 25.0 g/10 min or less, or 20.0 g/10 min or less, or 15.0 g/10 min or less, or 10.0 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less.

A “hydrolyzable silane monomer” is a silane-containing monomer that will effectively copolymerize with an α-olefin (e.g., ethylene) to form an α-olefin/silane copolymer (such as an ethylene/silane copolymer), or graft to an α-olefin polymer (i.e., a polyolefin) to form a Si-g-PO, thus enabling subsequent crosslinking of the silane-functionalized polyolefin. A representative, but not limiting, example of a hydrolyzable silane monomer has structure (I):

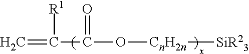

in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl. The hydrolyzable silane monomer may be copolymerized with an α-olefin (such as ethylene) in a reactor, such as a high-pressure process to form an α-olefin-silane copolymer (“i.e., a reactor copolymer”). In examples where the α-olefin is ethylene, such a copolymer is referred to herein as an ethylene-silane copolymer. The hydrolyzable silane monomer may also be grafted to a polyolefin (such as a polyethylene) by the use of an organic peroxide, such as 2,5-bis(tert-butylperoxy)-2,5-dimethylhexane, to form a Si-g-PO or an in-situ Si-g-PO. The in-situ Si-g-PO is formed by a process such as the MONOSIL™ process, in which a hydrolyzable silane monomer is grafted onto the backbone of a polyolefin during the extrusion of the present composition to form a coated conductor, as described, for example, in U.S. Pat. No. 4,574,133.

The hydrolyzable silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. In a specific example, the hydrolyzable silane monomer is an unsaturated alkoxy silane, which can be grafted onto the polyolefin or copolymerized in-reactor with an α-olefin (such as ethylene). Examples of hydrolyzable silane monomers include vinyltrimethoxysilanc (VTMS), vinyltriethoxysilane (VTES), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²-ethoxy; and for vinyltriacetoxysilane: x=0; R¹=H; and R²=acetoxy.

Examples of suitable ethylene-silane copolymers are commercially available as SI-LINK™ DFDA-5451 NT and SI-LINK™ AC DFDB-5451 NT, each available from The Dow Chemical Company, Midland, Mich.

The moisture curable polymeric composition may comprise from 10 wt % to 99 wt % of the silane-functionalized polyolefin. For example, the moisture curable polymeric composition comprises 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, or 98 wt % or greater, while at the same time, 99 wt % or less, or 95 wt % or less, or 93 wt % or less, or 90 wt % or less, 85 wt % or less, or 80 wt % or less, 75 wt % or less, or 70 wt % or less, 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less of the silane-functionalized polyolefin based on the total weight of the moisture curable polymeric composition.

### Ethylene-Based Polymer

The polyolefin of the silane functionalized polyolefin may be an ethylene-based polymer. Additionally, the ethylene-based polymer may not be silane functionalized and it may used as a blend component in the formulation. The ethylene-based polymer may be a non-polar or polar ethylene-based polymer. As used herein, the term “non-polar” when used in connection with a polymer means that it comprises 0.1 wt % or less of a polar monomer or comonomer as measured using Nuclear Magnetic Resonance (“NMR”) or Fourier-Transform Infrared (“FTIR”) Spectroscopy or X-ray Fluorescence (XRF) techniques. As used herein, “ethylene-based” polymers are polymers in which greater than 50 wt % of the monomers are ethylene though other co-monomers may also be employed. Descriptions of “ethylene-based” polymers (both polar and non-polar) can be found in Patel, R., “Types and Basics of Polyethylene”, In: Mark A. Spalding and Ananda M. Chatterjee (eds.), Handbook of Industrial Polyethylene and Technology, Chapter 4. Scrivener, 2017. pp. 105-138. The polar ethylene-based polymer can include ethylene and one or more unsaturated ester (such as an alkyl acrylate, alkyl methacrylate, or vinyl carboxylate). The non-polar ethylene-based polymer can include ethylene and one or more C₃-C₂₀ α-olefin comonomers such as propylene, 1-butene, 1 pentene, 4-methyl-1-pentene, 1-hexene, and 1-octene. The ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weights, molecular weight distributions, densities, etc.). If a blend of ethylene-based polymers is employed, the polymers can be blended by any in-reactor or post-reactor process. The term “multimodal” refers to polymers that are characterized by having at least two distinct peaks in a gel permeation chromatography (GPC) chromatogram depicting the molecular weight distribution of the composition. Accordingly, the generic term multimodal polymer includes bimodal polymers, which have two primary fractions: a first fraction, which may be a low molecular weight fraction and/or component, and a second fraction, which may be a high molecular weight fraction and/or component.

The ethylene-based polymer may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 98.5 wt % or greater, or 99 wt % or greater, or 99.5 wt % or greater, while at the same time, 100 wt % or less, or 99.5 wt % or less, or 99 wt % or less, or 98.5 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of ethylene based on the total weight of the ethylene-based polymer as measured using NMR or FTIR Spectroscopy or XRF. Other units of the ethylene-based polymer may include unsaturated ester (such as an alkyl acrylate, alkyl methacrylate, or vinyl carboxylate) or α-olefins (C₃, or C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene).

The ethylene-based polymer may have a density of 0.850 g/cc to 0.970 g/cc g/cc or less as measured according to ASTM D792. For example, the ethylene-based polymer may have a density of 0.850 g/cc or greater, 0.860 g/cc or greater, or 0.870 g/cc or greater, or 0.880 g/cc or greater, or 0.890 g/cc or greater, or 0.900 g/cc or greater, or 0.910 g/cc or greater, or 0.915 g/cc or greater, or 0.920 g/cc or greater, or 0.921 g/cc or greater, or 0.922 g/cc or greater, or 0.925 g/cc or greater, or 0.928 g/cc or greater, while at the same time, 0.970 g/cc or less, or 0.960 g/cc or less, or 0.950 g/cc or less, or 0.940 g/cc or less, or 0.930 g/cc or less, or 0.925 g/cc or less, or 0.920 g/cc or less, or 0.915 g/cc or less, or 0.910 g/cc or less, or 0.900 g/cc or less, or 0.890 g/cc or less, or 0.880 g/cc or less, or 0.870 g/cc or less, or 0.865 g/cc or less, or 0.860 g/cc or less, or 0.855 g/cc or less as measured by ASTM D792.

The ethylene-based polymer may have a melt index as measured according to ASTM D1238 under the conditions of 190° C./2.16 kilogram (kg) weight and is reported in grams eluted per 10 minutes (g/10 min). The melt index of the ethylene-based polymer may be 0.3 g/10 min or greater, or 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, or 5.0 g/10 min or greater, or 5.5 g/10 min or greater, or 6.0 g/10 min or greater, while at the same time, 30.0 g/10 min or less, or 25.0 g/10 min or less, or 20.0 g/10 min or less, or 15.0 g/10 min or less, or 10.0 g/10 min or less, or 6.0 g/10 min or less, or 5.5 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less, or 0.5 g/10 min or less.

The ethylene-based polymer may be a polar ethylene-based polymer. As used herein, the term “polar” when used in connection with a polymer means that it comprises 0.1 wt % or more of a polar monomer or comonomer as measured using NMR or FTIR Spectroscopy or XRF techniques. Units other than ethylene of the polar ethylene-based polymer may be derived from one or more polymerizable monomers including, but not limited to, acids and unsaturated esters. The acids may be acrylic acid and methacrylic acid. The unsaturated esters may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2-ethylhexyl acrylate. Examples of vinyl carboxylates include, but are not limited to, vinyl acetate, vinyl propionate, and vinyl butanoate. The polar ethylene-based polymer typically has a high level of long chain branching.

The density of the polar ethylene-based polymer may be from 0.925 g/cc to 0.985 g/cc as measured according to ASTM D792. For example, the density of the polar ethylene-based polymer may be 0.925 g/cc or greater, or 0.930 g/cc or greater, or 0.935 g/cc or greater, or 0.940 g/cc or greater, 0.945 g/cc or greater, or 0.950 g/cc or greater, or 0.955 g/cc or greater, or 0.960 g/cc or greater, or 0.965 g/cc or greater, or 0.970 g/cc or greater, or 0.975 g/cc or greater, or 0.980 g/cc or greater, while at the same time, 0.985 g/cc or less, or 0.980 g/cc or less, or 0.975 g/cc or less, or 0.970 g/cc or less, or 0.965 g/cc or less, or 0.960 g/cc or less, or 0.955 g/cc or less, or 0.950 g/cc or less, or 0.945 g/cc or less, or 0.940 g/cc or less, or 0.935 g/cc or less, or 0.930 g/cc or less as measured according to ASTM D792.

The moisture curable polymeric composition may comprise from 0 wt % to 40 wt % of the ethylene-based polymer that is not silane functionalized. The ethylene-based polymer that is not silane functionalized may be added alone and/or as part of a masterbatch of the intumescent flame-retardant mixture. For example, the moisture curable polymeric composition comprises 0 wt % or greater, or 1 wt % or greater, or 5 wt % or greater, 10 wt % or greater, or 15 wt % or greater, or 20 wt % or greater, or 25 wt % or greater, or 30 wt % or greater, or 35 wt % or greater, while at the same time, 40 wt % or less, or 35 wt % or less, or 30 wt % or less, or 25 wt % or less, or 20 wt % or less, or 15 wt % or less, or 10 wt % or less, or 5 wt % or less of the ethylene-based polymer based on the total weight of the moisture curable polymeric composition.

### Halogen-Free Flame Retardant

The moisture curable polymeric composition may comprise a halogen-free flame retardant. The halogen-free flame retardant can inhibit, suppress, or delay the production of flames. As used herein, “halogen-free” and like terms indicate that the flame-retardant filler is without or substantially without halogen content, i.e., contains less than 10,000 mg of halogen per kg of flame-retardant filler as measured by ion chromatography (IC) or a similar analytical method. Halogen content of less than this amount is considered inconsequential to the efficacy of the flame-retardant filler as, for example, in a coated conductor (also referred to as an insulated wire). Examples of the halogen-free flame retardants suitable for use in the moisture curable polymeric composition include, but are not limited to, intumescent flame retardants and other halogen-free flame retardants including metal hydrates (such as aluminum hydroxide, magnesium hydroxide), metal carbonates, red phosphorous, silica, alumina, Brucite (mineral form of magnesium hydroxide), metal oxides (such as zinc oxide, calcium oxide, magnesium oxide, titanium oxide), carbon nanotubes, talc, clay, organo-modified clay, calcium carbonate, zinc borate, antimony trioxide, wollastonite, mica, ammonium octamolybdate, frits, hollow glass microspheres, intumescent materials or compounds, expanded graphite, and combinations thereof. In an embodiment, the other halogen-free flame retardant is selected from fillers that have hydroxide moieties (such as metal hydrates) and/or hydroxyl groups (such as silica). In an embodiment, the metal hydrate of the other halogen-free flame retardant can be selected from the group consisting of aluminum hydroxide, magnesium hydroxide, calcium hydroxide, zinc hydroxide, iron hydroxide, copper hydroxide, and combinations thereof. In an embodiment, the other halogen-free flame retardant is selected from the group consisting of a metal hydrate, metal oxide, silica, and combinations thereof. The other halogen-free flame retardant can optionally be surface treated (coated) with a silane, or a saturated or unsaturated carboxylic acid having 8 to 24 carbon atoms, or 12 to 18 carbon atoms, or a metal salt of the acid, or other materials. Exemplary surface treatments are described in U.S. Pat. Nos. 4,255,303, 5,034,442, 7,514,489, US 2008/0251273, and WO 2013/116283. Alternatively, the silane or acid or salt can be merely added to the composition in like amounts rather than using the surface treatment procedure. Other surface treatments known in the art may also be used including titanates, phosphates and zirconates.

Commercially available examples of other halogen-free flame retardants suitable for use in the moisture curable polymeric composition include, but are not limited to, APYRAL™ 40CD aluminum hydroxide available from Nabaltec AG, MAGNIFIN™ H5 magnesium hydroxide available from Magnifin Magnesiaprodukte GmbH & Co KG, Microcarb 95T ultramicronized and treated calcium carbonate available from Reverte, and combinations thereof.

The moisture curable polymeric composition may comprise other halogen-free flame retardants in a concentration of 0 wt %, or 0.1 wt % or greater, or 0.5 wt % or greater, or 1 wt % or greater, or 3 wt % or greater, or 5 wt % or greater, or 7 wt % or greater, or 10 wt % or greater, or 12 wt % or greater, or 14 wt % or greater, or 16 wt % or greater, or 18% or greater, or 20 wt % or greater, or 22 wt % or greater, or 24 wt % or greater, or 26 wt % or greater, or 28% or greater, or 30 wt % or greater, or 32 wt % or greater, or 34 wt % or greater, or 36 wt % or greater, or 38% or greater, 40 wt % or greater, or 42 wt % or greater, or 44 wt % or greater, or 46 wt % or greater, or 48% or greater, while at the same time, 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less, or 20 wt % or less, or 18 wt % or less, or 16 wt % or less, or 14 wt % or less, or 12 wt % or less, or 10 wt % or less, or 7 wt % or less, or 5 wt % or less, or 3 wt % or less, or 1 wt % or less, or 0.5 wt % or less based on the total weight of the moisture curable polymeric composition.

### Intumescent Flame-Retardant Mixture

The moisture curable polymeric composition comprises the intumescent flame-retardant mixture as HFFR filler. The intumescent flame-retardant mixture may comprise piperazine pyrophosphate and a phosphoric acid compound. The intumescent flame-retardant mixture may comprise from 45 wt % to 85 wt % piperazine pyrophosphate based on the total weight of the intumescent flame-retardant mixture. For example, the intumescent flame-retardant mixture may comprise 45 wt % or greater, or 50 wt % or greater, or 55 wt % or greater, or 60 wt % or greater, or 65 wt % or greater, or 70 wt % or greater, or 75 wt % or greater, or 80 wt % or greater, while at the same time, 85 wt % or less, or 80 wt % or less, or 75 wt % or less, or 70 wt % or less, or 65 wt % or less, or 60 wt % or less, or 55 wt % or less, or 50 wt % or less, or 45 wt % or less of the piperazine pyrophosphate based on the total weight of the intumescent flame-retardant mixture.

The intumescent flame-retardant mixture may comprise from 15 wt % to 55 wt % of the phosphoric acid compound based on the total weight of the intumescent flame-retardant mixture. For example, the intumescent flame-retardant mixture comprises 15 wt % or greater, or 20 wt % or greater, or 25 wt % or greater, or 30 wt % or greater, or 35 wt % or greater, or 40 wt % or greater, or 45 wt % or greater, or 50 wt % or greater, while at the same time, 55 wt % or less, or 50 wt % or less, or 45 wt % or less, or 40 wt % or less, or 35 wt % or less, or 30 wt % or less, or 25 wt % or less, or 20 wt % or less of phosphoric acid compound based on the total weight of the intumescent flame-retardant mixture.

The phosphoric acid compound may be made of one or more materials. The phosphoric acid compound may be a salt formed by the reaction of phosphoric acid or polyphosphoric acid with amines. The phosphoric acid compound may be selected from one of melamine polyphosphate (a reaction product of melamine and polyphosphoric acid), ammonium polyphosphate (a reaction product of ammonia and polyphosphoric acid), or a combination thereof.

The intumescent flame-retardant mixture may comprise from 0 wt % to 20 wt % of a flame-retardant synergist based on the total weight of the intumescent flame-retardant mixture. For example, the intumescent flame-retardant mixture may comprise 0 wt % or greater, or 0.5 wt % or greater, or 1.0 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, or 10 wt % or greater, while at the same time, 20 wt % or less, or 18 wt % or less, or 16 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less, or 5 wt % or less, or 4 wt % or less, or 3 wt % or less, or 2 wt % or less, or 1 wt % or less, or 0.5 wt % or less, or 0 wt % of the flame retardant synergist based on the total weight of the intumescent flame-retardant mixture. The flame-retardant synergist in the intumescent flame-retardant mixture may be a silicone component (such as, but not limited to, silicone gum). The flame-retardant synergist in the intumescent flame-retardant mixture may be a metal oxide. In an embodiment, the flame-retardant synergist in the intumescent flame-retardant mixture is zinc oxide.

The moisture curable polymeric composition comprises from 1 wt % to 90 wt % of the intumescent flame-retardant mixture as HFFR filler based on the total weight of the polymeric composition. For example, the polymeric composition comprises 1 wt % or greater, or 5 wt % or greater, or 7 wt % or greater, or 10 wt % or greater, or 15 wt % or greater, or 20 wt % or greater, or 25 wt % or greater, or 30 wt % or greater, or 31 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, while at the same time, 90 wt % or less, or 85 wt % or less, or 80 wt % or less, or 75 wt % or less, or 70 wt % or less, or 65 wt % or less, or 60 wt % or less, or 55 wt % or less, less, 50 wt % or less, or 45 wt % or less, or 40 wt % or less, or 35 wt % or less, or 31 wt % or less, or 30 wt % or less, or 25 wt % or less, or 20 wt % or less, or 15 wt % or less, or 10 wt % or less, or 5 wt % or less of the intumescent flame-retardant mixture based on the total weight of the moisture curable polymeric composition.

### Additives

The moisture curable polymeric composition may include one or more additives. Nonlimiting examples of suitable additives include antioxidants, colorants, corrosion inhibitors, lubricants, ultraviolet (UV) absorbers or stabilizers, anti-blocking agents, moisture scavengers (including hydrolyzable silane monomers), silanol condensation catalysts, flame-retardants, coupling agents, compatibilizers, plasticizers, fillers, processing aids, propylene polymers (homopolymers and copolymers including polypropylene homopolymer, random copolymer polypropylene and impact copolymer polypropylene), and combinations thereof. Compatibilizers include, but are not limited to, anhydride modified ethylene-based polymers (such as anhydride modified ethylene plastomers or elastomers).

The moisture curable polymeric composition may include an antioxidant. Nonlimiting examples of suitable antioxidants include phenolic antioxidants, thio-based antioxidants, phosphate-based antioxidants, and hydrazine-based metal deactivators. Suitable phenolic antioxidants include high molecular weight hindered phenols, methyl-substituted phenol, phenols having substituents with primary or secondary carbonyls, and multifunctional phenols such as sulfur and phosphorous-containing phenol. Representative hindered phenols include 1,3,5-trimethyl-2,4,6-tris-(3,5-di-tert-butyl-4-hydroxybenzyl)-benzene; pentaerythrityl tetrakis-3 (3,5-di-tert-butyl-4-hydroxyphenyl)-propionate; n-octadecyl-3 (3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]. The polymeric composition may include pentaerythritol tetrakis(3-(3,5-di-tert-butyl-4-hydroxyphenyl) propionate), commercially available as Irganox™ 1010 from BASF. A nonlimiting example of a suitable methyl-substituted phenol is isobutylidenebis(4,6-dimethylphenol). A nonlimiting example of a suitable hydrazine-based metal deactivator is oxalyl bis(benzylidiene hydrazide). The moisture curable polymeric composition may contain from 0 wt %, or 0.001 wt %, or 0.01 wt %, or 0.02 wt %, or 0.05 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt % antioxidant, based on total weight of the moisture curable polymeric composition.

The moisture curable polymeric composition may include an ultraviolet (UV) absorber or stabilizer. A nonlimiting example of a suitable UV stabilizer is a hindered amine light stabilizer (HALS). A nonlimiting example of a suitable HALS is 1,3,5-Triazine-2,4,6-triamine, N,N-1,2-ethanediylbisN-3-4,6-bisbutyl(1,2,2,6,6-pentamethyl-4-piperidinyl)amino-1,3,5-triazin-2-ylaminopropyl-N,N-dibutyl-N,N-bis(1,2,2,6,6-pentamethyl-4-piperidinyl)-1,5,8,12-tetrakis[4,6-bis(n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains from 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt % UV absorber or stabilizer, based on total weight of the composition.

The moisture curable polymeric composition may include a processing aid. Nonlimiting examples of suitable processing aids include oils, organic acids (such as stearic acid), and metal salts of organic acids (such as zinc stearate). In an embodiment, the composition contains from 0 wt %, or 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 10.0 wt %, or 20.0 wt % processing aid, based on total weight of the composition.

The moisture curable polymeric composition may comprise from 0 wt % or greater, or 0.001 wt % or greater, or 0.002 wt % or greater, or 0.005 wt % or greater, or 0.006 wt % or greater, or 0.008 wt % or greater, or 0.009 wt % or greater, or 0.01 wt % or greater, or 0.2 wt % or greater, or 0.3 wt % or greater, or 0.4 wt % or greater, or 0.5 wt % or greater, or 1.0 wt % or greater, or 2.0 wt % or greater, or 3.0 wt % or greater, or 4.0 wt % or greater, or 5.0 wt % or greater, or 10.0 wt % or greater, or 15.0 wt % or greater, or 20.0 wt % or greater, or 30 wt % or greater, or 40 wt % or greater, or 50 wt % or greater additive, based on the total weight of the moisture curable polymeric composition.

### Crosslinking the Moisture Curable Polymeric Composition

The present disclosure is also directed to a method of method of crosslinking the moisture curable polymeric composition to form a moisture cured polymeric composition. Such a method includes a step of creating a moisture curable polymeric composition of a silane functionalized polyolefin and an intumescent flame-retardant mixture, wherein the intumescent flame-retardant mixture comprises piperazine pyrophosphate and from 15 wt % to 55 wt % of a phosphoric acid compound based on the total weight of the intumescent flame-retardant mixture. Once the moisture curable polymeric composition is created, it may be crosslinked to form the moisture-cured polymeric composition.

The moisture curable polymeric composition may be converted to a moisture cured polymeric composition by catalyzing a moisture-induced crosslinking reaction of the silane functionalized polyolefin using the intumescent flame-retardant mixture to form the moisture cured polymeric composition. As used herein, the term “moisture cured” means that the curing process is performed in the presence of water and that water is a necessary component in the curing process. For example, the step of catalyzing the moisture-induced crosslinking reaction may be carried out in one of a water bath at a temperature greater than 50° C. or in a gaseous atmosphere having a temperature of 15° C. or greater and a relative humidity of 10% or greater as measured according to ASTM E337. The gaseous atmosphere may be air at room temperature and humidity, such as 23° C. and 50% relative humidity.

The curing process is performed by inducing the hydrolyzable silane monomers of the silane-functionalized polyolefin to undergo a condensation reaction. The condensation reaction of the hydrolyzable silane monomers results in cross-linking of the polymer chains of the silane functionalized polyolefin chains thereby causing a curing of the silane functionalized polyolefin. While such a reaction may take place in the presence of water also, practical manufacturing and engineering considerations in the manufacture of the moisture-cured polymeric composition often dictate that a catalyst is used to increase the speed of the condensation reaction and ultimately speed the cure of the moisture-cured polymeric composition. As explained above, it is believed that an acid moisture cure catalyst may be generated upon thermal dissociation of the phosphoric acid compound which results in an increase in the speed of the moisture cured reaction. Such a feature is advantageous for a variety of reasons. First, the fact that the intumescent flame-retardant mixture may also be used as a catalyst is advantageous in that it eliminates the compounding complexity of the moisture curable polymeric composition because fewer distinct ingredients are needed thus simplifying manufacturing. Second, as the intumescent flame-retardant mixture does not contain materials such as tin and other potential substances of concern, resulting moisture cured polymeric compositions may face less regulatory pressure.

According to a feature of the disclosure, a method of crosslinking a moisture curable polymeric composition, the method comprising the steps of: creating a moisture curable polymeric composition of a silane functionalized polyolefin and an intumescent flame-retardant mixture, wherein the intumescent flame-retardant mixture comprises piperazine pyrophosphate and from 15 wt % to 55 wt % of a phosphoric acid compound based on the total weight of the intumescent flame-retardant mixture; and catalyzing a moisture-induced crosslinking reaction of the silane functionalized polyolefin using the intumescent flame-retardant mixture to form a moisture cured polymeric composition.

According to another feature of the disclosure, the step of catalyzing the moisture-induced crosslinking reaction is carried out in one of a water bath at a temperature greater than 50° C. or in a gaseous atmosphere having a temperature of 15° C. or greater and a relative humidity of 10% or greater as measured according to ASTM E337.

According to another feature of the disclosure, the moisture curable polymeric composition comprises 10 wt % to 99 wt % of the silane functionalized polyolefin based on a total weight of the moisture curable polymeric composition and the silane functionalized polyolefin is a silane functionalized ethylene-based polymer.

According to another feature of the disclosure, 4 the silane functionalized ethylene-based polymer comprises from 0.1 wt % to 5.0 wt % of silane groups based on the total weight of the silane functionalized ethylene-based polymer.

According to another feature of the disclosure, the silane is vinyltrimethoxysilane.

According to another feature of the disclosure, the moisture curable polymeric composition comprises 1 wt % to 90 wt % of the intumescent flame-retardant mixture based on a total weight of the moisture curable polymeric composition.

According to another feature of the disclosure, the polymeric composition comprises 1 wt % to 30 wt % of the intumescent flame-retardant mixture based on a total weight of the moisture curable polymeric composition.

According to another feature of the disclosure, the intumescent flame-retardant mixture comprises from 25 wt % to 45 wt % of the phosphoric acid compound based on the total weight of the intumescent flame-retardant mixture.

According to another feature of the disclosure, the phosphoric acid compound is selected from the group consisting of melamine polyphosphate, ammonium polyphosphate, or combinations thereof.

According to another feature of the disclosure, the moisture curable polymeric composition is free of dibutyltin dilaurate and sulfonic acid.

### Moisture Cured Polymeric Composition

The moisture curable polymeric composition may be converted to a moisture cured polymeric composition by catalyzing a moisture-induced crosslinking reaction of the silane functionalized polyolefin using the intumescent flame-retardant mixture to form the moisture cured polymeric composition. Catalyzing the moisture-induced crosslinking reaction may be carried out in one of a water bath at a temperature greater than 50° C. or in a gaseous atmosphere having a temperature of 15° C. or greater and a relative humidity of 10% or greater as measured according to ASTM E337. The gaseous atmosphere may be air at room temperature and humidity, such as 23° C. and 50% relative humidity.

The moisture cured polymeric composition exhibits one or more of the following properties: a peak tensile strength of 4 megapascals (MPa) or greater as measured according to ASTM D638; a tensile elongation at break of 50% or greater as measured according to ASTM D638; gel content of 10 wt % or greater as measured according to ASTM D2765; and 175% or less hot creep as measured according to UL 2556 Section 7.9. The moisture cured polymeric composition may exhibit a peak tensile strength of 4 MPa or greater, or 6 MPa or greater, or 8 MPa or greater, or 10 MPa or greater, or 12 MPa or greater, or 14 MPa or greater, or 16 MPa or greater, or 18 MPa or greater, while at the same time, 20 MPa or less, or 18 MPa or less, or 16 MPa or less, or 14 MPa or less, or 12 MPa or less, or 10 MPa or less, or 8 MPa or less, or 6 MPa or less as measured according to ASTM D638. The moisture cured polymeric composition may exhibit a tensile elongation at break of 50% or greater, or 75% or greater, or 100% or greater, or 125% or greater, or 150% or greater, or 175% or greater, or 200% or greater, or 225% or greater, or 250% or greater, or 275% or greater, or 300% or greater, or 325% or greater, or 350% or greater, or 375% or greater, while at the same time, 400% or less, or 375% or less, or 350% or less, or 325% or less, or 300% or less, or 275% or less, or 250% or less, or 225% or less, or 200% or less, or 175% or less, or 150% or less, or 125% or less, or 100% or less, or 75% or less as measured according to ASTM D638. The moisture cured polymeric composition may exhibit 10% or greater, or 20% or greater, or 30% or greater, or 40% or greater, or 50% or greater, or 60% or greater, or 70% or greater gel content as measured according to ASTM D2765. The moisture cured polymeric composition may exhibit 175% or less, or 150% or less, or 125% or less, or 100% or less, or 75% or less, or 50% or less, or 25% or less hot creep as measured according to UL 2556 Section 7.9.

### Coated Conductor

The present disclosure also provides a coated conductor. The coated conductor includes a conductor and a coating on the conductor, the coating including the moisture cured polymeric composition. The moisture cured polymeric composition is at least partially disposed around the conductor to produce the coated conductor. The conductor may comprise a conductive metal and/or an optical waveguide. The coated conductor may, in other words, be known as a wire, fiber optic, cable, or other connector.

The moisture cured polymeric composition is disposed on and/or around the conductor to form a coating. The coating may be one or more inner layers such as an insulating layer. The coating may wholly or partially cover or otherwise surround or encase the conductor. The coating may be the sole component surrounding the conductor as an insulation or jacket. Alternatively, the coating may be one layer of a multilayer jacket or sheath encasing the conductor. The coating may directly contact the conductor. The coating may directly contact an insulation layer surrounding the conductor.

The coated conductor may pass a UL-2556 Horizontal Burn Test.

### Examples

### Test Methods

Melt Index: Melt index (MI) values were measured in accordance with ASTM D1238 at 190° C. or 150° C. and using load of 2.16 kg or 21.6 kg.

Density was measured according to ASTM D792, Method B or calculated as follows: For a given formulation, the “mL per 100 grams” of each ingredient or component was obtained by dividing “wt %” of that ingredient by its density in g/cm³. The individual values of “mL per 100 grams” of each ingredient were added to yield a total value of “mL per 100 grams” for that particular formulation. Next, the number “100” (representing the total wt % of all ingredients in that formulation) was divided by the total value of “mL per 100 grams”, to yield the “calculated density” of that specific formulation in g/cm³. Density measured or calculated provided the same or similar results. For measurements, specimens were prepared according to ASTM D 1928. Samples were made by compression molding as described ahead. Density measurements were made after 40 hours of sample pressing, using ASTM D792, Method B.

Peak Heat Release Rate (PHRR): PHRR data were collected using cone calorimetry. Cone calorimetry was conducted on a Fire Testing Technology cone calorimeter at heat flux of 50 kW/m² and a distance of 25 mm between top of the sample surface and the bottom of the heater on horizontally set-up square specimens of 100 mm×100 mm×3 mm dimensions with a grid using the standardized cone calorimeter procedure (ASTM E-1354-11). A more in-depth description of this test is given in the following publication: Cogen, J. M., Chaudhary, B. I., Ghosh-Dastidar, A., Sun, Y. and Wasserman, S. H., “Flame Retardant Aspects of Crosslinked Polyethylene (XLPE)”, In: Jince Thomas, Sabu Thomas and Zakiah Ahmad (eds.), Crosslinkable Polyethylene—Manufacture, Properties, Recycling and Applications, Chapter 9. Springer, 2021. pp. 211-245.

Limiting oxygen index (LOI) was measured in accordance with ASTM D2863 and reflects the minimum concentration of oxygen, expressed as a percentage, that will support combustion of a polymer specimen. It is measured by passing a mixture of oxygen and nitrogen over a burning specimen, and adjusting the oxygen level until a critical level is reached.

Horizontal burn testing of a coated conductor was conducted in accordance with UL-2556. The test was performed by placing the coated conductor in a horizontal position. Cotton was placed underneath the coated conductor. A burner was set at a 20° angle relative to the horizontal sample of 14 American Wire Gauge (“AWG”) copper wire with 30 mil (0.762 mm) coating wall thickness. A one-time flame was applied to the middle of the sample for 30 seconds. A sample was deemed to fail if (i) the cotton ignited and/or (ii) the sample charred in excess of 100 mm. Char length was measured in accordance with UL-1581, 1100.4.

Hot creep (also known as hot creep elongation) of polymeric compositions (i.e., coating removed from insulated wires, i.e., coated conductors) was measured according to UL 2556 Section 7.9 or ICEA-T-28-562-2003 at a specified temperature (either 250° C. or 200° C. or 150° C.) under a fixed stress (0.2 MPa). The lower the hot creep measurement, the higher the degree of crosslinking.

In the case of coated conductors, tensile peak stress (also known as tensile strength) and tensile strain at break (also known as tensile elongation) of polymeric compositions was measured according to Underwriter's Laboratory (“UL”) 2556, Section 3.5 at a displacement rate of 20 inch (508 mm) per minute and at 23° C. and 50% relative humidity. The averages of four or five measurements were determined. Each test specimen was prepared by removing the polymeric composition coating (insulation) from a coated conductor without damaging it.

Tensile properties were also measured of extruded tape or compression molded samples made of the polymeric compositions, in accordance with ASTM D638-14, at a displacement rate of 20 inch (508 mm) per minute (using Type IV dog bone-shaped specimens obtained from the tapes or compression molded samples).

Gel content of polymeric compositions (i.e., coating removed from insulated wires, i.e., coated conductors) was determined by extraction with the solvent decahydronaphthalene (Decalin) at boiling conditions for 6 hours according to ASTM D2765. The higher the gel content, the higher the degree of crosslinking.

Silane Testing: Use x-ray fluorescence spectroscopy (“XRF”) to determine weight percent (wt %) of silicon atom (Si) content of, and then calculate silane comonomeric unit wt % in, test samples of the ethylene-silane copolymer. Using a Buehler SimpliMet 300 automatic mounting press that is preheated for 3 minutes at 115.6° C. (240 degrees Fahrenheit (° F.)), press a powdered form of test sample for 1 minute under 8.3 megapascals (MPa; 1,200 pounds per square inch (psi)) to form a plaque having a thickness of about 6 mm, and cool the plaque to 25° C. Analyze the Si atom content of the plaque by wavelength dispersive XRF using a wavelength dispersive X-ray fluorescence spectrometer from PANalytical Axios. Determine Si atom content by comparing its line intensity in the XRF spectrum to a calibration curve for Si atom content that is established using polymer standards of known Si atom concentrations as independently measured using Neutron Activation Analysis (NAA) or Inductively Coupled Plasma (ICP) methods. Use the XRF measured Si atom wt % value, and the molecular weight(s) of the at least one silane comonomer from which the hydrolyzable silyl groups were derived, to calculate hydrolyzable silyl group comonomeric unit wt % (i.e., wt % of the hydrolyzable silyl groups) in the ethylene-silane copolymer. For hydrolyzable silyl groups derived from vinyltrimethoxysilane (VTMS), use the VTMS molecular weight of 148.23 g/mol. To calculate hydrolyzable silyl group content of (wt % of hydrolyzable silyl group comonomeric units in) the ethylene-silane copolymer, use the XRF obtained Si atom wt % (“C”) and the following formula: p=C*(m/28.086) (1/10000 ppmw), wherein * means multiplication, / means division, p is wt % hydrolyzable silyl groups in ethylene-silane copolymer, C is the Si atom amount (XFR) in weight parts per million (ppmw), m is the molecular weight in g/mol of the silane comonomer from which the hydrolysable silyl groups are derived, 28.086 is the atomic weight of a silicon atom, and 10000 ppmw is the number of weight parts per million in 1.00 wt %. For example, when XRF shows 379 ppmw of Si atom in ethylene-silane copolymer and the comonomer used to make the ethylene-silane copolymer is VTMS having a molecular weight of 148.23 g/mol, the wt % comonomeric content is 0.20 wt %. To calculate mol % of hydrolyzable silyl group comonomeric units in the ethylene-silane copolymer of the silane comonomer used, use the calculated wt % of the hydrolyzable silyl group comonomeric units in ethylene-silane copolymer and the following equation: G=100*(p/m)/[(p/m)+ (100.00 wt %−p)/28.05 g/mol], wherein * means multiplication, G is mole percent (mol %) of hydrolyzable silyl groups in the ethylene-silane copolymer; p is wt % of hydrolyzable silyl groups in ethylene-silane copolymer, m is molecular weight in g/mol of the silane comonomer from which the hydrolyzable silyl groups are derived, and 28.05 g/mol is the molecular weight of monomer ethylene (H2C═CH2). For example, when comonomeric content is 2.0 wt % and the comonomer is VTMS, p=2.0 wt % and m=148.23 g/mol, and G=0.38 mol %. When comonomeric content is 5.0 wt % and the comonomer is VTMS, p=5.0 wt % and m=148.23 g/mol, and G=0.99 mol %. When two or more silane comonomers having different molecular weights are used to make ethylene-silane copolymer, the molecular weight used in the calculation of the total mol % of all hydrolyzable silyl groups in ethylene-silane copolymer is a weighted average molecular weight of the comonomers. The weighting may be determined by the proportion of the amounts of the comonomers fed into the reactor; alternatively by NMR spectroscopy on the ethylene-silane copolymer to determine the relative amounts of the different comonomeric units in the ethylene-silane copolymer when the respective hydrolyzable silyl groups are bonded to different types of carbon atoms (e.g., tertiary versus secondary carbon atoms); alternatively by Fourier Transform Infrared (FT-IR) spectroscopy calibrated to provide quantitation of the different types comonomers.

Crystallinity Testing: determine melting peaks and percent (%) or weight percent (wt %) crystallinity of ethylene polymers at 23° C. using Differential Scanning calorimeter (DSC) instrument DSC Q1000 (TA Instruments). (A) Baseline calibrate DSC instrument. Use software calibration wizard. Obtain a baseline by heating a cell from −80° to 280° C. without any sample in an aluminum DSC pan. Then use sapphire standards as instructed by the calibration wizard. Analyze 1 to 2 milligrams (mg) of a fresh indium sample by heating the standards sample to 180° C., cooling to 120° C. at a cooling rate of 10° C./minute, then keeping the standards sample isothermally at 120° C. for 1 minute, followed by heating the standards sample from 120° C. to 180° C. at a heating rate of 10° C./minute. Determine that indium standards sample has heat of fusion=28.71±0.50 Joules per gram (J/g) and onset of melting=156.6°+0.5° C. (B) Perform DSC measurements on test samples using the baseline calibrated DSC instrument. Press test sample of semi-crystalline ethylenic polymer into a thin film at a temperature of 160° C. Weigh 5 to 8 mg of test sample film in aluminum DSC pan. Crimp lid on pan to seal pan and ensure closed atmosphere. Place lid-sealed pan in DSC cell, equilibrate cell at 30° C., and then heat at a rate of about 100° C./minute to 190° C., keep sample at 190° C. for 3 minutes, cool sample at a rate of 10° C./minute to −60° C. to obtain a cool curve heat of fusion (Hf), and keep isothermally at −60° C. for 3 minutes. Then heat sample again at a rate of 10° C./minute to 190° C. to obtain a second heating curve heat of fusion (ΔHf). Using the second heating curve, calculate the “total” heat of fusion (J/g) by integrating from −20° C. (in the case of ethylene homopolymers, copolymers of ethylene and hydrolysable silane monomers, and ethylene alpha olefin copolymers of density greater than or equal to 0.90 g/cm³) or −40° C. (in the case of copolymers of ethylene and unsaturated esters, and ethylene alpha olefin copolymers of density less than 0.90 g/cm³) to end of melting. Using the second heating curve, calculate the “room temperature” heat of fusion (J/g) from 23° C. (room temperature) to end of melting by dropping perpendicular at 23° C. Measure and report “total crystallinity” (computed from “total” heat of fusion) as well as “Crystallinity at room temperature” (computed from 23° C. heat of fusion). Room temperature refers to 23° C. Crystallinity is measured and reported as percent (%) or weight percent (wt %) crystallinity of the polymer from the test sample's second heating curve heat of fusion (ΔHf) and its normalization to the heat of fusion of 100% crystalline polyethylene, where % crystallinity or wt % crystallinity=(ΔHf*100%)/292 J/g, wherein ΔHf is as defined above, * indicates mathematical multiplication,/indicates mathematical division, and 292 J/g is a literature value of heat of fusion (ΔHf) for a 100% crystalline polyethylene.

### Materials

The materials used in the inventive examples (“IE”) and comparative examples (“CE”) are provided below.

ESC is an ethylene-silane copolymer containing a moisture scavenger and is characterized by a melt index (190° C.; 2.16 kg) of 1.5 g/10 minutes, a density of 0.922 g/cc, a copolymerized VTMS content of 1.6 wt % (0.31 mol %) and a crystallinity at 23° C. of 46.8 wt %. ESC is available from The Dow Chemical Company, Midland, Michigan.

CAT MB is a silanol condensation catalyst masterbatch (blend of thermoplastic ethylenic polymers, antioxidants, and about 3 wt % of dibutyltin dilaurate) developed to be used in conjunction with moisture curable ethylene-silane copolymers and is commercially available as SI-LINK™ DFDA-5481 NT from The Dow Chemical Company, Midland, MI.

POLAR is a polar ethylene ethyl acrylate copolymer (ethylene-based polymer) having a density of 0.930 g/cc, a melt index (190° C.; 2.16 kg) of 1.3 g/10 min, and a 15 wt % ethyl acrylate content. POLAR is commercially available as AMPLIFY™ EA 100 Functional Polymer from The Dow Chemical Company, Midland, MI, United States.

NPEP1 is a non-polar linear low-density polyethylene, LLDPE, (i.e., an ethylene-based polymer) having a density of 0.920 g/cc and a melt index (190° C.; 2.16 kg) of 3.5 g/10 min and is commercially available as DOW™ LLDPE 1648 from The Dow Chemical Company, Midland, MI, United States.

NPEP2 is a non-polar polyolefin elastomer (i.e., an ethylene-based polymer) having a density of 0.870 g/cc and a melt index (190° C.; 2.16 kg) of 5 g/10 min and is commercially available as ENGAGE™ 8200 from The Dow Chemical Company, Midland, MI, United States.

COMP is an anhydride modified ethylene elastomer (ethylene-based polymer) compatibilizer and is commercially available as FUSABOND™ N216 from The Dow Chemical Company, Midland, MI.

HFFR1 is uncoated aluminum hydroxide (ATH) and is commercially available as APYRAL™ 40CD from Nabeltec AG, Schwandorf, Germany.

HFFR2 is magnesium hydroxide (MDH) that is stearic acid treated at maximum 1 wt %, and is commercially available as ECOPIREN 3.5LC from Europiren B. V., Rotterdam, NL.

IFRM is a halogen free flame retardant (HFFR) that is an intumescent flame-retardant mixture of 65 wt % piperazine pyrophosphate and 35 wt % melamine polyphosphate with a nitrogen content ≥19%, phosphorus content ≥17.0% and water content≤0.2%. The piperazine pyrophosphate is of 1.74 g/cc density and melamine polyphosphate has a density of 1.85 g/cc, meaning that the density of IFRM is 1.78 g/cc. IFRM is commercially available as JNP™-2-3 from CENTURY MULTECH, INC, Flushing, NY, United States).

GPS is a combination of ultra high molecular weight silicone gum and fumed silica in pellet form that is commercially available as GENIOPLAST™ Pellet S from Wacker Chemie AG, Munich, Germany.

AO1 is pentaerythritol tetrakis[3-[3,5-di-tert-butyl-4-hydroxyphenyl]propionate and is commercially available as IRGANOX™ 1010 from BASF, Ludwigshafen, Germany.

AO2 is distearyl thio dipropionate (C₄₂H8204S) and is commercially available as MORSTILLE™ 18C DSTDP from Struktol, OH, United States.

MDAO is Bis(3,5-di-tert-butyl-4-hydroxyhydrocinnamoyl) hydrazine which serves as a metal deactivator and antioxidant. MDAO is commercially available as IRGANOX™ MD 1024 FF from BASF Corporation, Florham Park, NJ, United States.

MD is FUTURECHEM™ OABH (oxalyl bis(benzylidene) hydrazide) which serves as a metal deactivator. MD is commercially available from FutureFuel Chemical Company, Missouri, USA.

LSAO is C₁₃₂H₂₅₀N₃₂ and functions as a hindered amine light stabilizer and antioxidant. LSAO is commercially available as CHIMASSORB™ 119 FL from SABO Spa, Italy.

CAT is dibutyltin dilaurate and functions as a silanol condensation catalyst when used in combination with alkoxysilane functionalized polymers. CAT has a CAS number of 77-58-7 and is commercially available as FASCAT™ 4202 from PMC Organometallix, Mount Laurel, NJ, US.

OTS is Octyltriethoxysilane which functions as a moisture scavenger and is commercially available as PROSIL™ 9202 from SiVance LLC, of Milliken & Co, USA. It is useful in combination with alkoxysilane functionalized polymers.

### Sample Preparation

The sample formulation of Masterbatch 1 (MB1) in Table 1 was prepared using a Brabender mixer equipped with Cam rotors and resulting bowl volume of 420 mL at a rotor speed of 50 rpm and set temperature of 125° C. while filling 70% of the bowl volume. The HFFR filler (IFRM) was dried for 16 hr at 60° C. in a vacuum oven before use. The ethylene-based polymer(s) was/were fluxed in the mixing bowl for 5 minutes before adding the other ingredients. The order of addition was ethylene-based polymer(s), antioxidant(s), IFRM and other additives. When adding the various solid ingredients, the mixing blade speed was reduced to about 20 rpm. After all the ingredients had been added, mixing was done for 5 minutes.

The procedure used to prepare the sample formulation of Masterbatch 2 (MB2) was the same as that for MB1, except for: (a) using roller blades at rotor speed of 40 rpm with resulting bowl volume of 350 mL; (b) using a set temperature of 150° C.; (c) mixing for 10 minutes after all the ingredients had been added; and (d) not drying the IFRM before use.

The procedure used to prepare the sample formulation of Masterbatch 3 (MB3) was the same as that for MB2, except for the order of addition being as follows: ethylene-based polymer(s), COMP2, GPS, antioxidant(s), MD, HFFR4, HFFR5, IFRM, OTS and CAT.

Each of the melt-blended compositions of MB1 to MB3 was removed from the mixing bowl and compression molded at 120° C. with 500 psi (3.4 MPa) pressure for 5 minutes into a plaque/sheet of 75 mil (1.905 mm) thickness that was subsequently was cut into strips using guillotine which were fed to a pelletizer, to make “chips”. These “chips” were next introduced to a Brabender ¾″ extruder equipped with a Maddock mixing screw of 25:1 length-to-diameter (L/D) ratio operated at 40 rpm with set temperature profile of 140° C./145° C./150° C./155° C. across zone 1, zone 2, zone 3 and head/die (using a 40/60/100 mesh screen pack). The composition was fabricated into a strand that in turn was converted to pellets using a pelletizer. The pellets were dried for 16 to 24 hours at 70° C. in a vacuum oven and thereafter packaged in a vacuum-sealed foil bag until the time of use. Where appropriate, for testing of properties, plaques of 75 mil (1.905 mm) or 125 mil (3.175 mm) thickness were prepared by compression molding at 500 psi (3.4 MPa) at 150° C. for 3 minutes, followed by 2500 psi (17.2 MPa) at 150° C. for 3 minutes, followed by cooling to 30° C. at 2500 psi (17.2 MPa) pressure.

The sample formulations of IE1-IE11 and CE1 in Table 2 were used to prepare coated conductors. In the case of IE1-IE11, this was done by melt blending by extrusion any one of MB1 to MB3 with ESC (ethylene-silane copolymer) and, in the case of IE2 also with CAT MB, in the proportions shown in Table 2, using the following experimental procedures. CE1 was made by melt blending by extrusion CAT MB with ESC in the proportions indicated in Table 2, using the experimental procedure presented below.

IE1 and IE2: Physical blends (in a plastic bag) were made of the pellets of ESC, MB1 and/or CAT MB. The pellet blends were fed to a Brabender ¾″ extruder equipped with a Maddock screw of 25:1 length-to-diameter (L/D) ratio and melt extruded to apply a coating (insulation layer) of nominal 30 mil (0.762 mm) wall thickness to a 14 AWG solid copper conductor of the following dimensions: conductor nominal diameter: 0.064 inch (1.626 mm); and insulated wire nominal outside diameter: 0.124 inch (3.150 mm). The set temperature profile across the extruder zones was 165° C., 170° C., 175° C., and 180° C. at the head/die. A 40/40 mesh screen pack was employed and the screw speed was 40 rpm, with the haul away belt speed being 8 ft/min (2.4 m/min). The resulting melt temperature was about 188-189° C. in both cases.

IE3 to IE10 and CE1: Same as for IE1 and IE2, except for: (a) using MB2; (b) making CE1 without any of MB1 to MB3; (c) the set temperature profile across the extruder zones was 145° C., 150° C., 155° C., and 160° C. at the head/die; (d) the screw speed was about 40-41 rpm, with the haul away belt speed being about 8.5 ft/min (2.6 m/min); and (e) the resulting melt temperature was about 165-166° C. in all cases.

IE11: Same as for IE3 to IE10 except for: (a) using MB3; (b) the pellet blends were fed to a Brabender 1¼″ extruder equipped with a Maddock screw of 20:1 length-to-diameter (L/D) ratio and melt extruded to apply a coating (insulation layer) of nominal 55 mil (1.397 mm) wall thickness to a 4 mm² (ca. 11 AWG) stranded tin-copper conductor of the following dimensions: conductor nominal diameter: 0.090 inch (2.286 mm); and insulated wire nominal outside diameter: 0.200 inch (5.080 mm); (c) the haul away belt speed was about 9.5 ft/min (2.9 m/min); and (d) the resulting melt temperature was about 169° C.

### Results

Table 1 provides the compositional and performance property data for masterbatch materials (“MB”) used in the formation of the inventive examples. Table 2 provides compositional data related to IE1-IE11 and CE1. Table 3 provides performance data related for the moisture cured examples of IE1-IE11 and CE1. NA means that a sample's identified data was not measured.

TABLE 1

| Ingredient (wt %) | MB1 | MB2 | MB3 |
|---|---|---|---|
| POLAR | 0.39 | | |
| NPEP1 | 26.43 | | |
| NPEP2 | | 28.79 | 26.26 |
| COMP | | | 4.00 |
| HFFR1 | | | 26.30 |
| HFFR2 | | | 26.30 |
| IFRM | 72.72 | 70.00 | 11.00 |
| GPS | | | 4.30 |
| AO1 | 0.30 | 0.38 | 0.38 |
| AO2 | | 0.38 | 0.38 |
| MDAO | 0.15 | | |
| MD | | 0.45 | 0.45 |
| LSAO | 0.01 | | |
| CAT | | | 0.13 |
| OTS | | | 0.50 |
| TOTAL | 100.00 | 100.00 | 100.00 |
| Ethylene-Based Polymer | 26.82 | 28.79 | 26.26 |
| (wt %) | | | |
| Calculated density, g/cm³ | 1.420 | 1.360 | 1.465 |
| Measured density, g/cm³ | NA | 1.365 | 1.472 |
| Melt Index (150° C.; 21.6 | NA | 1.9 | 5.1 |
| kg), dg/min | | | |
| Tensile Strength (Peak | NA | 3.3 | 5.1 |
| Stress), MPa | | | |
| Tensile Elongation (Strain at | NA | 713 | 249 |
| Break), % | | | |
| Peak Heat Release Rate | NA | 53.76 | 148.74 |
| (kW/m²) | | | |
| Limiting Oxygen Index, | NA | 65 | 35 |
| LOI (%) | | | |

NA: Not Available

TABLE 2

| Ingredient | | | | | | | | | | | | |
|---|---|---|---|---|---|---|---|---|---|---|---|---|
| (wt %) | IE1 | IE2 | IE3 | IE4 | IE5 | IE6 | IE7 | IE8 | IE9 | IE10 | IE11 | CE1 |
| ESC | 55.0 | 55.0 | 95.0 | 90.0 | 80.0 | 70.0 | 60.0 | 50.0 | 40.0 | 30.0 | 22.0 | 95.0 |
| MB1 | 45.0 | 40.0 | | | | | | | | | | |
| MB2 | | | 5.0 | 10.0 | 20.0 | 30.0 | 40.0 | 50.0 | 60.0 | 70.0 | | |
| MB3 | | | | | | | | | | | 78.0 | |
| CAT MB | | 5.0 | | | | | | | | | | 5.0 |
| TOTAL | 100.0 | 100.0 | 100.0 | 100.0 | 100.0 | 100.0 | 100.0 | 100.0 | 100.0 | 100.0 | 100.0 | 100.0 |
| IFRM (wt %) | 32.7 | 29.1 | 3.5 | 7.0 | 14.0 | 21.0 | 28.0 | 35.0 | 42.0 | 49.0 | 8.6 | 0.0 |
| HFFR1 (wt %) | 0.0 | 0.0 | 0.0 | 0.0 | 0.0 | 0.0 | 0.0 | 0.0 | 0.0 | 0.0 | 20.5 | 0.0 |
| HFFR2 (wt %) | 0.0 | 0.0 | 0.0 | 0.0 | 0.0 | 0.0 | 0.0 | 0.0 | 0.0 | 0.0 | 20.5 | 0.0 |
| Measured | NA | NA | 0.9351 | 0.9462 | 0.9701 | 1.0095 | 1.0283 | 1.0629 | 1.1009 | 1.1293 | 1.2468 | 0.9212 |
| density, g/cm³ | | | | | | | | | | | | |

TABLE 3

| Properties after Moisture-Cure | IE1 | IE2 | IE3 | IE4 | IE5 | IE6 |
|---|---|---|---|---|---|---|
| Gel Content, wt % | 66.47 | 53.70 | 67.84 | 71.34 | 71.02 | 72.16 |
| Hot Creep - after 24 hr in 90° C. | 29.45 * | 34.06 * | Broke | Broke | Broke | Broke |
| Water, % | | | | | | |
| Hot Creep - after 72 hr in 90° C. | NA | NA | NA | NA | NA | NA |
| Water, % | | | | | | |
| Hot Creep - after 96 hr in 90° C. | NA | NA | Broke | Broke | 42.76 | 53.96 |
| Water, % | | | | | | |
| Tensile Strength (Peak Stress) - | 1318 ** | 1529 ** | 2188 | 1853 | 2408 | 1815 |
| after 96 hr in 90° C. Water, (MPa) | | | | | | |
| Tensile Elongation (Strain at Break) - | 130 ** | 169 ** | 372 | 304 | 320 | 290 |
| after 96 hr in 90° C. Water, % | | | | | | |
| Horizontal Burn: Percentage of | 100 * | 100 * | 0 | 0 | 33 | 100 |
| Specimens That Passed Out of 1 or | | | | | | |
| 3 Tested - after 96 hr in 90° C. Water | | | | | | |
| Horizontal Burn: Average Char | 38 * | 37 * | 230 | 230 | 108 | 40 |
| Length (mm) - after 96 hr in 90° C. | | | | | | |
| Water | | | | | | |
| Horizontal Burn: Dripping | No * | No * | No | No | No | No |
| Observed? - after 96 hr in 90° C. | | | | | | |
| Water | | | | | | |
| Horizontal Burn: Cotton Ignited? - | No * | No * | No | No | No | No |
| after 96 hr in 90° C. Water | | | | | | |

| Properties after Moisture-Cure | IE7 | IE8 | IE9 | IE10 | IE11 | CE1 |
|---|---|---|---|---|---|---|
| Gel Content, wt % | 59.87 | 43.30 | 39.86 | 32.44 | NA | 83.59 |
| Hot Creep - after 24 hr in 90° C. | Broke | Broke | 126.10 | 106.09 | NA | 25.87 |
| Water, % | | | | | | |
| Hot Creep - after 72 hr in 90° C. | NA | NA | NA | NA | 41.21 | NA |
| Water, % | | | | | | |
| Hot Creep - after 96 hr in 90° C. | 42.87 | NA | NA | NA | NA | 15.75 |
| Water, % | | | | | | |
| Tensile Strength (Peak Stress) - | 1644 | 1395 | 1201 | 1085 | 1143 | 2401 |
| after 96 hr in 90° C. Water, (MPa) | | | | | | |
| Tensile Elongation (Strain at Break) - | 244 | 245 | 242 | 275 | 223 | 231 |
| after 96 hr in 90° C. Water, % | | | | | | |
| Horizontal Burn: Percentage of | 100 | 100 | 100 | 100 | NA | 0 |
| Specimens That Passed Out of 1 or | | | | | | |
| 3 Tested - after 96 hr in 90° C. Water | | | | | | |
| Horizontal Burn: Average Char | 36 | 35 | 37 | 42 | NA | 230 |
| Length (mm) - after 96 hr in 90° C. | | | | | | |
| Water | | | | | | |
| Horizontal Burn: Dripping | No | No | No | No | NA | Yes |
| Observed? - after 96 hr in 90° C. | | | | | | |
| Water | | | | | | |
| Horizontal Burn: Cotton Ignited? - | No | No | No | No | NA | Yes |
| after 96 hr in 90° C. Water | | | | | | |

For Table 3, the “properties after moisture-cure” were determined of insulated wires (i.e., coated conductors) that had been cured at 23° C., 50% relative humidity for 1 week (except those marked * or **), followed by 90° C. water bath for 24 hours or 72 hours or 96 hours. The hot creep measurements were made at a test temperature of 150° C. in all cases (IE1 to IE11 and CE1).

*: Tested after cure at 23° C., 50% relative humidity for 6 months, followed by 90° C. water bath for 24 hours.

** Tested after cure at 23° C., 50% relative humidity for 1 month, followed by 90° C. water bath for 24 hours.

Referring now to Tables 2 and 3, CE1 is representative of conventional formulations that require so-called moisture-cure (silanol condensation) catalysts for crosslinking to achieve high gel content and thus exhibit satisfactory hot creep performance (<175% hot creep). In contrast to CE1, the compositions of IE1 and IE3 to IE10 were surprisingly able to achieve sufficiently high gel contents and/or pass the hot creep test after cure in the hot water bath, even without the use of a catalyst. Furthermore, the inventive compositions passed the hot creep test even when the gel contents measured by decalin extraction were relatively low. Without any catalyst being used, the inventive examples containing relatively high loadings of IFRM required 24 hours cure in the 90° C. water bath to exceed the hot creep pass requirement, after an initial cure for about 1 week at ambient conditions of 23° C. and 50% relative humidity. Extending the cure time in the hot water bath to 96 hours enabled even those inventive formulations containing comparatively lower amounts of IFRM to robustly pass the hot creep test. The surfaces of all the insulated wires of IE1 to IE11 were smooth, as was that of the coated conductor of CE1, indicating that premature crosslinking (during melt blending by extrusion, i.e., melt extrusion) of the silane-functionalized polyolefin did not take place.

Additionally, as can be seen in IE3-IE10, the coated conductors (insulated wires) made of compositions containing 21 wt % or more IFRM exhibited strong passes in the horizontal burn test. However, even the compositions of IE6 to IE8 would inherently have some level of flame-retardancy by virtue of the presence of IFRM, perhaps sufficient for other burn/flame tests. IE11 with 8.6 wt % IFRM, 20.5 wt % HFFR1 and 20.5 wt % MFFR2 (the latter two being metal hydrate flame retardants) would also be expected to exhibit good flame-retardancy. Note that the horizontal burn test was not conducted on IE11 because it was not of the required construction for this test (i.e., 14 AWG copper wire with 30 mil (0.762 mm) coating wall thickness).

From the hot creep data (IE2 and IE11), it is clear the intumescent flame-retardant mixture is compatible with conventional moisture-cure catalysts (such as dibutyltin dilaurate, a Lewis acid) that are used in such formulations to enable silane crosslinking of the resulting HFFR compositions. Such a feature is advantageous as such conventional catalysts can be incorporated in the inventive formulations to shorten cure times significantly.

1. A moisture curable polymeric composition comprising:
10 wt % to 99 wt % of a silane-functionalized polyolefin based on the total weight of the moisture curable polymeric composition; and
1 wt % to 90 wt % of an intumescent flame-retardant mixture based on the total weight of the moisture curable polymeric composition, wherein the intumescent flame-retardant mixture comprises piperazine pyrophosphate and from 15 wt % to 55 wt % of a phosphoric acid compound based on the total weight of the intumescent flame-retardant mixture.

2. The moisture curable polymeric composition of claim 1, wherein the silane functionalized polyolefin is a silane functionalized ethylene-based polymer.

3. The moisture curable polymeric composition of claim 2, wherein the polymeric composition comprises 30 wt % or greater of the silane functionalized polyolefin based on a total weight of the moisture curable polymeric composition.

4. The moisture curable polymeric composition of claim 1, wherein the polymeric composition comprises 15 wt % or greater of the intumescent flame-retardant mixture based on a total weight of the moisture curable polymeric composition.

5. The moisture curable polymeric composition of claim 1, wherein the intumescent flame-retardant mixture comprises from 25 wt % to 45 wt % of phosphoric acid compound based on the total weight of the intumescent flame-retardant mixture.

6. The moisture curable polymeric composition of claim 5, wherein the phosphoric acid compound is selected from the group consisting of melamine polyphosphate, ammonium polyphosphate, or combinations thereof.

7. The moisture curable polymeric composition of claim 1, wherein the moisture curable polymeric composition exhibits a density of 1.70 g/cc or less as measured according to ASTM D792.

8. The moisture curable polymeric composition of claim 1, wherein the moisture curable polymeric composition is free of dibutyltin dilaurate and sulfonic acid.

9. A moisture cured polymeric composition prepared from the moisture curable polymeric composition of claim 1, wherein the moisture cured polymeric composition exhibits one or more of the following properties:
a peak tensile strength of 4 megapascals or greater as measured according to ASTM D638;
a tensile elongation at break of 50% or greater as measured according to ASTM D638; and
175% or less hot creep as measured according to UL 2556 Section 7.9.

10. A coated conductor, comprising
a conductor; and
the moisture-cured polymeric composition of claim 9 positioned around the conductor.

11. The coated conductor of claim 10, wherein the coated conductor passes a UL-2556 Horizontal Burn Test.
